(19) United States
(12) Patent Application Publication
(10) Pub. No.: US 2008/0179775 A1
(43) Pub. Date: Jul. 31, 2008

(54) Transfer Plate Useful in the Manufacture of Panel and Board Products

(75) Inventors: Gregory O. Palm, Buffalo Grove, IL (US); Steven W. Sucech, Lake Villa, IL (US); John J. Polyner, Esko, MN (US); Ray C. Privett, Proctor, MN (US); Stephen Schettler, Hermantown, MN (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: USG Interiors, Inc., Chicago, IL (US)

(21) Appl. No.: 11/669,310

(22) Filed: Jan. 31, 2007

(51) Int. Cl. B28B 1/26

(52) U.S. Cl. 264/87; 406/78

(57) ABSTRACT

The invention provides an apparatus for forming a panel comprising a mesh support and a transfer plate comprising at least one surface comprising a plurality of pores having an average pore diameter of about 1200 microns or less. The invention further provides a method comprising (i) forming an aqueous composition comprising a fiber material, (ii) depositing the composition onto a movable mesh support to form an entangled fiber material containing water; (iii) removing at least a portion of the water from the entangled fiber material, and (iv) transferring the entangled fiber material from the movable mesh support by passing it over a transfer plate, wherein the transfer plate comprises at least one surface comprising a plurality of pores having an average pore diameter of about 1200 microns or less.

### BACKGROUND OF THE INVENTION

The manufacture of panel and board products generally involves a manufacturing line comprising different regions (e.g., cutting region, drying region, dewatering region, etc.) which employ different movable means of support including belts, rollers, mesh supports, and the like. Often transfer plates are used to support a panel or board precursor material during the transition from one region to the next. However, in some cases, the transfer plate becomes a source of defects in the final board product because the transfer of the precursor material over the transfer plate is not smooth. The appearance of flaws relating to the use of a transfer plate is particularly observed in porous and/or brittle products such as acoustical panels and wood fiber board.

Acoustical panels are used to form interior surfaces, such as ceiling tiles, wall panels, and other partitions (e.g., partitions between office cubicles), in commercial or residential buildings. The panels are generally planar in shape and include an acoustical layer containing a combination of materials selected to provide suitable acoustic absorbency while retaining sufficient durability. For example, common materials presently used in forming acoustical panels include mineral wool, fiberglass, expanded perlite, clay, calcium sulfate hemihydrate, calcium sulfate dihydrate particles, calcium carbonate, paper fiber, and binder such as starch or latex. Mineral wool is most commonly used because it helps create a porous fibrous structure and thus provides good sound absorption.

Many acoustical panels are prepared in a manner similar to conventional papermaking processes by water-felting dilute aqueous dispersions of mineral wool, perlite, binder, and other ingredients as desired. Such processes are described, for example, in U.S. Pat. Nos. 4,212,704, 5,013,405, 5,250,153, 5,558,710, 5,911,818, 5,964,934, 6,228,497, 6,443,256, 6,855,753, and 7,056,582, each of which are incorporated by reference herein. In such processes, the dispersion flows onto a moving mesh support (commonly referred to as a “wire”), such as that of an Oliver or Fourdrinier mat forming machine for dewatering, as will be appreciated by one of ordinary skill in the art. The dispersion dewaters first by gravity and then by vacuum suction. The wet mat is dried in a heated convection oven, and the dried material is cut to desired dimensions and optionally top-coated with paint to obtain a finished panel.

At some point during the manufacturing process described above, the wet mat typically is transferred from the movable mesh support to another section of the manufacturing line, for example to a set of rollers, to another mesh support, or to a belt. Typically this transfer is facilitated by the use of a transfer plate which supports the mat and thereby prevents it from breaking apart as it transitions from the mesh support to such another region of the manufacturing line. During this transfer step, portions of the wet mat, for example bits of mineral wool that stick out from the surface of the mat, can tear off and become stuck to the transfer plate.

Gypsum wood fiber board can be prepared using an Oliver or Fourdrinier mat forming machine for dewatering in a manner similar to acoustical panels described above. Such processes are described, for example, in U.S. Pat. Nos. 5,320,677, 5,817,262, 6,010,596, 6,197,235, 6,221,521, 6,406,779, 6,416,695, 6,508,895, 6,605,186, 6,733,261, 7,056,460, which are incorporated by reference herein. As with acoustical panels, at some point during the manufacturing of gypsum wood fiber board, a wet board precursor material is transferred from the movable mesh support to another section of the manufacturing line, for example to a set of rollers, to another mesh support, or to a belt. Typically this transfer is facilitated by the use of a transfer plate which supports the wet precursor material and thereby prevents it from breaking apart as it transitions from the mesh support to such another region of the manufacturing line. However during this transfer step, portions of the wet precursor material can break off and become stuck to the transfer plate.

The presence of material adhered to the transfer plate can negatively affect the appearance of the surface of the panel or board products. For example, the built-up material can gouge the face of a panel or board precursor material as it moves over the transfer plate. In some cases, the manufacturing line eventually must be shut down so that the built-up material can be scraped from the transfer plate. Accordingly, there remains a need in the art for an improved transfer plate and method of transferring a wet panel or board precursor material from a mesh support to a subsequent section of the line.

The invention provides a transfer plate and method. These and other advantages of the invention as well as additional inventive features will be apparent from the description of the invention provided herein.

### BRIEF SUMMARY OF THE INVENTION

The invention provides an apparatus and method for forming a panel, such as an acoustical ceiling tile or gypsum wood fiber product. The invention relates to an improved transfer plate that facilitates the transfer of a panel precursor from a movable mesh support to another section of a manufacturing line. The improved transfer plate comprises a plurality of pores through which fluid such as air can flow. Applicants have discovered that air moving through the transfer plate surprisingly can act as a lubricant that facilitates the transfer of panel precursor materials over the transfer plate, acts to reduce or even eliminate build up of material on the transfer plate and thereby to minimize the downtime and waste of panel material associated with the need to periodically clean the transfer plate, and/or reduces or eliminates the appearance of defects on the surface of the panel.

In one embodiment, the invention provides an apparatus comprising a movable mesh support and a transfer plate, wherein the transfer plate comprises at least one surface comprising a plurality of pores having an average pore diameter of about 1200 microns or less. In a preferred embodiment, the pores are in fluid communication with a source of pressurized air. In other embodiments, the pores can be in fluid communication with a source of pressurized water or steam that acts as the lubricant, although the use of water or steam is generally less preferred in manufacturing methods which involve a dewatering step.

In another embodiment, the invention provides a method for manufacturing a panel comprising (i) forming an aqueous composition comprising a fiber material, (ii) depositing the composition onto a movable mesh support to form an entangled fiber material containing water; (iii) removing at least a portion of the water from the entangled fiber material, and (iv) transferring the entangled fiber material from the movable mesh support by passing it over a transfer plate, wherein the transfer plate comprises at least one surface comprising a plurality of pores having an average pore diameter of about 1200 microns or less.

In yet another embodiment, the invention provides a method for manufacturing a board product comprising (i) forming an aqueous composition comprising a cellulose fiber material and gypsum, (ii) depositing the composition onto a movable mesh support; (iii) heating the composition to convert gypsum to calcium sulfate hemihydrate; (iv) removing at least a portion of the water from the composition, and (v) transferring the composition from the movable mesh support by passing it over a transfer plate, wherein the transfer plate comprises at least one surface comprising a plurality of pores having an average pore diameter of about 1000 microns or less.

### BRIEF DESCRIPTION OF THE SEVERAL VIEWS OF THE DRAWING(S)

FIG. 1 is a schematic side view of a manufacturing line in accordance with the invention comprising a movable mesh support, a transfer plate, and a roller section.

FIG. 2 is a schematic top view of a transfer plate in accordance with the invention.

FIG. 3 is a schematic side view of a transfer plate in accordance with the invention.

### DETAILED DESCRIPTION OF THE INVENTION

The invention relates to an improved apparatus and method for forming a panel comprising the use of a porous transfer plate to facilitate transfer of a panel precursor from one section of a manufacturing line to another. For ease of discussion, “panel precursor” refers to the panel at any stage prior to its final form. Typically the panel precursor is a wet mat of fibrous material.

The inventors have discovered that the efficiency and quality of panel formation surprisingly and unexpectedly can be improved by using fluid such as air to lubricate the transfer of the panel precursor so as to prevent adhesion of portions of the panel precursor to the transfer plate. Panels produced using the apparatus or method of the invention thus have fewer defects resulting from gouging by material built up on the transfer plate, and are produced more efficiently because of the reduced need for down time to scrape away build-up from the transfer plate. The present invention has particular utility in apparatuses and methods of forming porous panels, in particular acoustical ceiling tiles, insulating panels, sound absorbing panels and the like; however, as one of ordinary skill in the art will appreciate, the invention can also be useful to facilitate transfer between one or more movable regions (e.g., mesh supports, rollers, belts, etc.) during manufacture of other board materials, including wood fiber board, and the like.

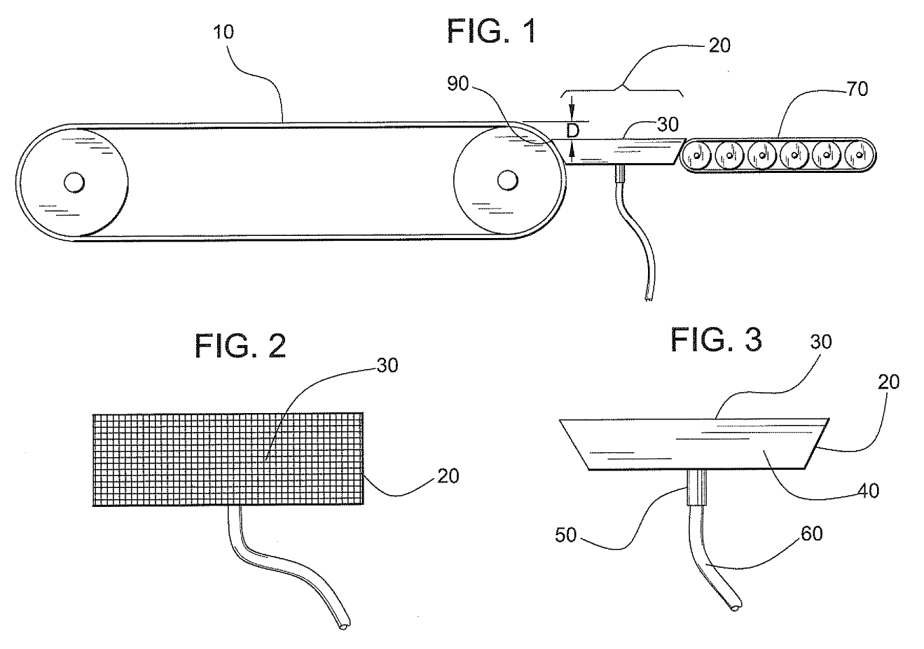

In one embodiment, the invention is directed to an apparatus for forming a panel comprising a movable mesh support and at least one transfer plate, wherein the transfer plate comprises at least one surface comprising a plurality of pores. As is depicted in FIG. 1, it is generally desirable that the transfer plate (20) is positioned relative to the movable mesh support (10) such that at least one surface (30) faces the underside of a wet panel precursor as it comes off the mesh support. In some embodiments it is desirable that two or more surfaces of the transfer plate include pores. For example, the transfer plate preferably has two surfaces comprising a plurality of pores, including the surface (30) and the leading edge surface (90). When both the surface (30) and the leading edge surface (90) are porous, air flows toward the panel precursor material from multiple directions thereby further assisting in the transfer of the panel precursor material.

The porous surface of the transfer plate desirably is positioned such that at least one porous surface (30) is coplanar with the mesh support. In some embodiments, the coplanar porous surface (30) of the transfer plate is at the same height as the mesh support (10). In other embodiments, the coplanar porous surface (30) is lower than the mesh support, as is depicted in FIG. 1. For example, in some embodiments, the porous surface (30) of the transfer plate can be lower than the mesh support (10) by a difference (D) of about 0.5 inches, or about 1 inch.

The pores should have a relatively small average pore diameter and should be evenly spaced across the surface of the transfer plate. When the panel being formed is a porous material, such as an acoustical panel, e.g., a ceiling tile panel, it is particularly important that the pore size and pore distribution are such that there is a uniform distribution of pressure across the entire width and length of the transfer plate on an inch and sub-inch scale. This is because the air can partially pass through the porous panel precursor material making it more difficult to lift and support the entire panel. In addition, small (i.e., averaging between 0.5 microns and 1200 microns), closely spaced pores are preferred because portions of the panel precursor are less likely to become lodged in small pores as the panel precursor moves over the transfer plate.

Accordingly, the surface of the transfer plate desirably has a mesh size (wires per inch) of about 16 mesh to about 2500 mesh (e.g., about 30 mesh to about 400 mesh, or about 50 mesh to about 200 mesh). Thus, typically the average pore diameter is about 1200 microns or less, or about 1000 microns or less. Desirably the average pore diameter is about 800 microns or less, about 500 microns or less, or about 200 microns or less. In some embodiments, it is desirable that the pores have an average pore diameter of about 100 microns or less, about 50 microns or less, or even about 20 microns or less. Also, typically the average pore diameter, in connection with any of the above upper ranges, is about 0.5 micron or more, or about 1 micron or more, or about 5 microns or more. Preferably, in some embodiments, the average pore size ranges from about 5 microns to about 1000 microns, about 20 microns to about 500 microns, about 40 microns to about 300 microns, or about 80 microns to about 200 microns.

The surface of the transfer plate can have any suitable number of pores, although it is desirable that the surface of the transfer plate have a large number of small pores that are closely spaced, as opposed to a small number of large pores that are spaced far apart. Typically the surface of the transfer plate comprises about 200 holes per square inch (about 30 holes/cm²) or more, about 1000 holes per square inch (about 140 holes/cm²) or more, or about 2000 holes per square inch (about 300 holes/cm²) or more. Preferably the surface comprises about 5,000 holes per square inch (about 750 holes/cm²) or more. More preferably the surface comprises about 10,000 holes per square inch (about 1550 holes/cm²) or more. In some embodiments, the surface comprises about 50,000 holes per square inch (about 8,000 holes/cm²) or more, or about 100,000 holes per square inch (about 16,000 holes/cm²) or more. Also, typically the surface of the transfer plate comprises, in connection with any of the above upper ranges, about 5,000,000 holes per square inch (about 800,000 holes/cm²) or less, or about 1,000,000 holes per square inch (about 140,000 holes/cm²) or less, or about 500,000 holes per square inch (about 75,000 holes/cm²) or less.

The air flow through the pores of the transfer plate can have any suitable pressure and flow rate. Desirably the average air pressure across the pores of the transfer plate is about 0.05 psi (about 0.3 kPa) to about 50 psi (about 340 kPa), about 0.1 psi (about 0.7 kPa) to about 30 psi (about 200 kPa), or about 0.5 psi (about 3 kPa) to about 20 psi (about 135 kPa). In addition, the average air flow through the pores of the transfer plate desirably is from about 0.1 cubic feet per minute (cfm) per square foot of transfer plate surface (about 0.03 cubic meter per minute per square meter of transfer plate surface) to about 200 cfm per square foot of transfer plate surface (about 60 cubic meter per minute per square meter of transfer plate surface), about 1 cubic feet per minute (cfm) per square foot of transfer plate surface (about 0.3 cubic meter per minute per square meter of transfer plate surface) to about 100 cfm per square foot of transfer plate surface (about 30 cubic meter per minute per square meter of transfer plate surface), or about 5 cubic feet per minute (cfm) per square foot of transfer plate surface (about 1.5 cubic meter per minute per square meter of transfer plate surface) to about 70 cfm per square foot of transfer plate surface (about 21 cubic meter per minute per square meter of transfer plate surface). In a preferred embodiment, the pores of the transfer plate are in fluid communication with a source of pressurized air or other suitable pressurized gas. The pressure, and accordingly the flow rate, of the pressurized air can be adjusted during the manufacturing process. The actual air pressure and air flow rate used will depend, at least in part, on the density of the panel precursor being prepared, as one of ordinary skill in the art will appreciate.

The transfer plate can have any suitable shape or size. In some embodiments, the transfer plate is rectangular in shape and extends across the width of the mesh support in the manufacturing line. Such a transfer plate is depicted in FIG. 2. The transfer plate can also have, for example, a square shape, a trapezoidal shape, or a 6- or 8-sided shape that resembles a rectangle having two or all of the corners cut off. In addition the transfer plate can be in the shape of a roller having a round or elliptical cross-section. Accordingly, the porous surface of the transfer plate can be flat or curved. Preferably, the surface is flat and coplanar with the mesh support.

The porous surface of the transfer plate can comprise any suitable material. The material preferably is substantially resistant to corrosion. The material can comprise a metal, a polymer, a ceramic, or combinations thereof. Suitable metals include, for example, stainless steel (316L, 304L, 310, 347, and 430), titanium, and metal alloys including Hastelloy (C-276, C-22, X, N, B, and B2), Inconel (600, 625, and 690), Nickel 200, Monel® 400 (70 Ni-30 Cu), Alloy 20, and the like. In a preferred embodiment, at least a portion, if not all (even more preferred) of the material is stainless steel. Suitable polymers include polypropylene, nylon, polycarbonate, polyester, polysulfone, polyethersulfone, fluoropolymers such as polyvinylidene fluoride and polytetrafluoroethylene (PTFE), and the like. Suitable ceramics include silica, alumina, zirconia, titania, glass, silicon carbide, and the like. The material can also be a ceramic-supported polymer membrane, for example a zirconia-PVP membrane or the like.

The surface of the transfer plate comprising the pores can be formed by any suitable method. For example, the surface can consist of a sheet with a plurality of microporous apertures cut or cast therein. By way of example, the porous surface can comprise a stainless steel membrane comprising about 1,500 holes per square inch or more. In some embodiments the porous surface comprises a stainless steel membrane comprising about 10,000 holes per square inch or more. Alternatively, the porous surface can comprise 2 or more compressed screens with, for example, about 1,500 to about 160,000 holes per square inch or greater, or, in some embodiments, about 10,000 to about 160,000 holes per square inch or greater. In addition, the porous surface of the transfer plate can comprise a porous metal material consisting of a compressed sintered metal powder. By way of example, the portion can comprise a Dynapore® FoilMesh™ LFM-1, LFM-5, or LFM-10 membrane, commercially available from Martin Kurz & Co., Inc. of Mineola, N.Y., or a 0.2 μm or 0.5 μm porous 316SS membrane, commercially available from Mott Corporation of Farmington, Conn.

As one of ordinary skill in the art will appreciate, a desired mesh size can be achieved by a variety of methods so long as the pores through which the air passes allow the air exiting the plate to contact the wet panel precursor passing over the transfer plate and inhibit bits of the panel precursor from tearing off and becoming adhered to the transfer plate. For example, a porous surface can be formed so as to have the desired number and size of apertures. Further, by way of illustration, and not in limitation of the invention, a surface with the desired mesh size can be achieved by forming a multi-layered structure of two or more screens, each of which has a pre-selected number and size of apertures therein, and combining the screens as, for example, by compressing and sintering the screens to produce the desired surface having the desired number and size of holes per square inch. While various combinations of screens can be used in any order suitable to form the surface of desired number and size of apertures per inch, in one embodiment, a multi-layer membrane comprises a base screen having the largest sized apertures, and successive screens having progressively smaller sized apertures but a larger number of apertures per inch leading to the top screen, wherein the top screen has the greatest number of apertures and the smallest sized apertures per square inch. It will also be appreciated by those skilled in the art that the porous surface selected or made for the transfer plate is preferably balanced with the desired air flow rate from the plate and the pressure head of the air in the plate.

In a preferred embodiment, the transfer plate (20) further comprises a chamber (40), which can act as a plenum and contain the pressurized air, an air inlet fitting (50) in fluid contact with the chamber, and an air inlet (60) for receiving fluid from a fluid source. The air inlet can comprise a hose, tube, or the like. The chamber can have any suitable dimensions. Desirably, the chamber is configured such that a constant flow rate and/or pressure drop exists across the entire portion of the porous portion of the transfer plate. Typically, the length of the chamber will be substantially equal to the length of the transfer plate. In some embodiments, it is desirable that the volume of the chamber is constant across the length and width of the chamber. The inlet can be placed at any suitable position on the transfer plate. Typically, the inlet is positioned opposite the surface of the transfer plate, which contacts the wet panel precursor.

The apparatus of the invention optionally comprises two or more transfer plates comprising a porous surface as described above. The additional transfer plates can be located in any suitable position, for example the additional transfer plate can be positioned at any transfer point between mesh supports, belts, roller sections, and the like. In some embodiments, multiple transfer plates are positioned side-by-side across the width and/or length of the manufacturing line. When there are multiple transfer plates in the apparatus, the transfer plates can be the same or different. In particular, multiple transfer plates can be positioned side-by-side, wherein each transfer plate has an independent control which allows in situ adjustment of the flow rate and/or pressure drop of the air through the pores. In one preferred embodiment, four transfer plates are positioned side-by-side across the width of the manufacturing line, wherein there is one main air pressure regulator controlling all of the transfer plates, and four additional air pressure regulators, one for each of the four transfer plates.

In another embodiment, the invention is directed to a method for manufacturing a panel comprising the use of the transfer plate. The inventive method can be used to prepare a variety of panels. For example, the panel can be an acoustical panel such as a ceiling tile or sound absorbing wall panel, an insulating panel, a gypsum wood fiber board product, or a structural insulation panel. In the case of acoustical panels such as ceiling tiles, the invention can be used in manufacturing such panels that contain mineral wool, but can also be used with such panels that are free of mineral wool. See, e.g., U.S. Pat. Nos. 6,228,497, 6,443,256 and 7,056,582, each of which is incorporated by reference herein. The inventive method and apparatus typically are used in connection with a continuous manufacturing process.

In one preferred embodiment, the method comprises (i) forming an aqueous composition comprising a fiber material, (ii) depositing the composition onto a movable mesh support to form an entangled fiber material containing water; (iii) removing at least a portion of the water from the entangled fiber material, and (iv) transferring the entangled fiber material from the movable mesh support by passing it over a transfer plate, wherein the transfer plate is as described above. The entangled fiber material can be transferred to any other portion of the manufacturing line; for example the material can be transferred to a roller section, another mesh support, or a belt. Typically the entangled fiber material is transferred to a roller section (70), as depicted in FIG. 1.

The fiber material can be any of the conventional mineral fibers prepared by attenuating a molten stream of basalt, slag, granite or other vitreous mineral constituent. The molten mineral is either drawn linearly through orifices, commonly referred to as textile fibers, or it is recovered tangentially off the face of a spinning cup or rotor, commonly referred to as wool fiber. Ceramic fibers and organic fibers such as polyamide fibers, acrylic fibers, polyester fibers, polyolefin fibers, cellulose fibers and the like may also be used. Expressed in terms of the dry solids content of the final panel product, the fiber constituent is suitably present in an amount of from about 10% to about 95% by weight depending on the desired density of the panel. Typically from about 30 to about 45% by weight fiber constituent is present. In some embodiments, it is desirable to use nodulated mineral wool to provide for an increased variety of decorative surfaces, as is described in U.S. Pat. No. 5,250,153, which is incorporated by reference herein. In other embodiments, it is desirable to further include coarse cellulose fibers to aid flotation and entanglement, as is described in U.S. Pat. No. 5,013,405, which is incorporated by reference herein.

The aqueous composition can comprise any suitable additives. The type and amount of additional additives will depend, of course, on the type of panel being produced. When the panel is a ceiling tile, the aqueous composition typically further comprises a lightweight inorganic aggregate, a binder, and optionally a foaming aid.

The lightweight inorganic aggregate can be any suitable material. For example, the aggregate ingredient may be a lightweight inorganic aggregate of exfoliated or expanded volcanic glass origin. Such aggregate includes the well known expanded perlite, exfoliated vermiculite, exfoliated clay and the like products which are available in a variety of mesh sizes. Generally, mesh sizes smaller than about 8 mesh are suitable, although this is not critical. Preferably the aggregate is perlite. The amount of aggregate included may range from about 20% to about 70% on a dry weight basis in the final product. For low density products, the lightweight aggregate will generally constitute about 30 to about 65% of the product. Higher density versions of the products, having densities up to about 22 pounds per cubic foot (about 0.36 g/cm³) or more, may be produced by employing higher density mineral aggregate such as stucco (calcium sulfate hemihydrate), gypsum, clays, limestone or the like.

The binder can be any suitable binder, many of which are known in the art. Typically the binder is a cooked starch binder or a resin latex binder that is a homopolymer or copolymer containing acrylic, acetate, or styrene-butadiene groups.

When the binder is a resin latex binder, the binder preferably is polyvinyl acetate (PVA) alone or in combination with polyvinyl alcohol. Any of the commercially available PVA latex resins containing an anionic particle charge emulsifier may be used, such as VINAC or AIRFLEX resins from Air Products Company, X-LINK latex or RESYN latex resins from National Starch and Chemicals Corporation, CASCOREZ resins from Borden Chemical Division of Borden, Inc., or the SYNTHEMUL 97-611 vinyl acetate/acrylic latex emulsion from Reichold Chemicals, Inc. These resins often have a glass transition temperature (Tg) of about 29° to 35° C. Other anionic type synthetic resin lattices such as vinylidene chloride, polyvinyl chloride, nitrile rubber, carboxylated acrylonitrile, polychloroprenes such as neoprene and the like or copolymers thereof may be used singly or in combination. The anionic polyvinyl acetate latex binders are available in various concentrations having a full range of viscosities. These polymers are available in a pH range of about 1-8, more often about 4 to about 8, although other pH ranges that do not adversely affect the mineral material may be used. They are commercially available in a range of particle sizes of about 0.1 to 2 microns.

A cooked starch binder can be used alone, or in combination with a latex binder so as to offset the high cost of the latex. Desirably the cooked starch is cooked so that the temperature rise is stopped after adhesive properties have been achieved but with reference to the inflection point on the viscosity/temperature curve for a particular starch to avoid a sharp increase in the viscosity. A viscous starch dispersion must be avoided so that the felted mass is not plugged up and flow through drying is made impossible. Strength and hardness may be imparted to the product, also. Suitable starches include a pearl starch and a wheat starch containing about 6% protein by weight such as GENVIS 600 wheat starch from Ogilvie Mills, Inc.

The binder solids may be present in the final product on a dry weight basis in an amount ranging from about 1% to about 35% depending upon the amount of mineral fiber, amount of lightweight aggregate, and the degree of stiffness and strength desired for the core of the final panel product. Preferably the amount of binder solids is from about 2% to about 25% on a dry weight basis, with from about 2% to about 10% being particularly preferred. The starch co-binder may be as much as about 80% of the weight of the binder solids. Thus, the binder in this invention may be from about 20 to about 100 weight percent resin latex and from about 0 to about 80 weight percent starch. At the higher levels of starch, a flocculent aid such as mentioned in U.S. Pat. No. 5,250,153 becomes increasingly important, It is preferred to keep the amount of starch at less than about 70 weight percent.

Other ingredients may also be present in the aqueous composition such as dyes, pigments, antioxidants, surfactants, water repellents, fillers, fire retardants, and the like. Suitable fillers include perlite, vermiculite, mica, wollastonite, silica, fly ash, gypsum, stucco (calcined gypsum) limestone, kaolin, ball clay, and the like. Surfactants include anionic surfactants such as linear alkyl sulfates and sulfonates and nonionic surfactants such as modified diethanolamide. Adding a small amount of the cationic coupling agent with the fillers and pigments appears to increase their retention. Colorants coupled to the mineral wool together with the latex impart intense integral colors to the product. A divalent or trivalent cation, such as calcium ions from calcium sulfate, may be used as a flocculation aid and to reduce the required level of polyacrylamide.

In some embodiments, the invention is useful in making gypsum wood fiber product. A method for manufacturing a board product in accordance with the present invention comprises (i) forming an aqueous composition comprising a cellulose fiber material and gypsum, (ii) depositing the composition onto a movable mesh support; (iii) heating or otherwise treating the composition to convert gypsum to calcium sulfate hemihydrate; (iv) removing at least a portion of the water from the composition, and (v) transferring the composition from the movable mesh support by passing it over a transfer plate in accordance with the invention. The composition is transferred to, for example, another section of a manufacturing line such as rollers, belts, or even another mesh support, or the like. The cellulose fibers typically are wood fibers which are combined with gypsum and optionally other additives to form a gypsum wood fiber composite board, as described in U.S. Pat. Nos. 5,320,677, 5,817,262, 6,010,596, 6,197,235, 6,221,521, 6,406,779, 6,416,695, 6,508,895, 6,605,186, 6,733,261, 7,056,460, which are incorporated by reference herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An apparatus for forming a panel comprising a movable mesh support and a transfer plate, wherein the transfer plate comprises at least one surface comprising a plurality of pores having an average pore diameter of about 1200 microns or less.

2. The apparatus of claim 1, wherein the pores of the transfer plate are in fluid communication with a source of pressurized air.

3. The apparatus of claim 1, wherein the pores of the transfer plate are in fluid communication with a source of water or steam.

4. The apparatus of claim 2, wherein air flows through the pores at an average pressure of about 0.05 psi to about 50 psi and an average air flow of about 0.1 cfm/ft² to about 200 cfm/ft².

5. The apparatus of claim 1, wherein the surface of the transfer plate comprises about 1,500 holes per square inch or more.

6. The apparatus of claim 1, wherein the surface of the transfer plate comprises 2 or more compressed metal screens.

7. The apparatus of claim 1, wherein the surface of the transfer plate comprises stainless steel.

8. The apparatus of claim 1, wherein the surface of the transfer plate is coplanar with the support.

9. The apparatus of claim 1, wherein the transfer plate comprises two or more surfaces comprising a plurality of pores having an average pore diameter of about 1200 microns or less, wherein one porous surface is coplanar with the support, and a second porous surface is a leading edge surface.

10. The apparatus of claim 1, wherein the pores have an average pore diameter of about 200 microns or less.

11. The apparatus of claim 1, wherein the transfer plate extends across the width of the mesh support.

12. The apparatus of claim 1, wherein the apparatus comprises two or more transfer plates positioned side-by-side across the width of the mesh support.

13. The apparatus of claim 12, wherein each transfer plate has independent control of air flow rate and air pressure.

14. The apparatus of claim 1, further comprising a roller section, wherein the transfer plate is positioned between the mesh support and the roller section.

15. A method for manufacturing a panel comprising:
(i) forming an aqueous composition comprising a fiber material,
(ii) depositing the composition onto a movable mesh support to form an entangled fiber material containing water;
(iii) removing at least a portion of the water from the entangled fiber material, and
(iv) transferring the entangled fiber material from the movable mesh support by passing it over a transfer plate,
wherein the transfer plate comprises at least one surface comprising a plurality of pores having an average pore diameter of about 1200 microns or less.

16. The method of claim 15, wherein the pores of the transfer plate are in fluid communication with a source of pressurized air.

17. The method of claim 15, wherein the surface of the transfer plate comprises 2 or more compressed metal screens.

18. The method of claim 15, wherein the surface of the transfer plate comprises stainless steel.

19. The method of claim 15, wherein the pores have an average pore size of about 200 microns or less.

20. The method of claim 15, wherein the aqueous composition further comprises a binder.

21. The method of claim 15, wherein the aqueous composition further comprises a lightweight inorganic aggregate.

22. The method of claim 15, wherein the transfer plate extends across the width of the mesh support.

23. The method of claim 15, wherein the surface of the transfer plate is coplanar with the mesh support.

24. The method of claim 15, wherein the surface of the transfer plate comprises about 1,500 holes per square inch or more.

25. The method of claim 15, wherein the entangled fiber material is transferred from the movable mesh support to a roller section.

26. The method of claim 15, wherein the panel is selected from the group consisting of an acoustical ceiling tile, an insulating panel, a sound absorbing wall panel, and a pipe and beam insulation panel.

27. The method of claim 15, wherein the fiber material is mineral fiber.

28. A method for manufacturing a board product comprising:
(i) forming an aqueous composition comprising a cellulose fiber material and gypsum,
(ii) depositing the composition onto a movable mesh support;
(iii) heating the composition to convert gypsum to calcium sulfate hemihydrate;
(iv) removing at least a portion of the water from the composition, and
(v) transferring the composition from the movable mesh support by passing it over a transfer plate,
wherein the transfer plate comprises at least one surface comprising a plurality of pores having an average pore diameter of about 1200 microns or less.
